(19) United States
(12) Patent Application Publication
(10) Pub. No.: US 2009/0295217 A1
(43) Pub. Date: Dec. 3, 2009

(54) Method and apparatus for the removal of floor coverings

(75) Inventor: Ruedi Dummermuth-Furter, Zunzgen (CH)

Correspondence Address: euromaier LLC, Ste 600, 707 Skokie Blvd,, Northbrook, IL, 60062, US

(73) Assignee: AIRTEC AG, Zunzgen (CH)

(21) Appl. No.: 12/463,752

(22) Filed: May 11, 2009

(30) Foreign Application Priority Data
May 28, 2008 (CH) 00811/08

(51) Int. Cl. E04G 23/02; B28D 1/18; E01C 23/00; E04G 23/00

(52) U.S. Cl. 299/10; 299/39.3

(57) ABSTRACT

A method and the associated apparatus for the removal of floor coverings are presented. The removal of floor coverings is achieved in that up to 24 grooves (21) with a width (b) of 3 mm to 10 mm and with a depth (t) of up to 40 mm are simultaneously milled into the floor covering (20) at spacings (a) of 5 mm to 30 mm. The ribs (22) occurring between the grooves (21) are then knocked off by simple means, such as hammers, chisels or picks.

In a second operation, by means of the same apparatus, further grooves (21) are milled transversely thereto, so that only rectangular elevations remain which can be knocked off with ease.

The present invention relates to a method and an apparatus for the removal of floor coverings according to the preamble of patent claim 1 and to an apparatus according to the preamble of patent claim 3.

For the processing of hard surfaces, road milling machines are known, for example, from DE 2948540, and large building machines for the removal of road coverings prior to renovation are likewise known, for example, from DE 19547698. These surface milling machines operate with drums to which milling cutters are fastened as working-off tools. Although the efficiency of such machines is not disputed, they cannot be used for the removal of floors inside houses which are provided with carpeting, laminate, concrete covering, stone slabs or other coverings. In underground garages, workshops and cellars, but also in living rooms and other spaces, the use of handy and nevertheless efficient machines may be perfectly desirable. Known machines cannot be used readily for these applications. The vibrations generated by the known machines are harmful for the building structure, and therefore such machines are not well suited to operating inside buildings.

The object of the present invention, then, is to develop and improve a method and an apparatus which can also be used for the conversion and renovation of closed spaces.

This object is achieved by means of a method having the features of patent claim 1, which can be carried out, using the apparatus as claimed in claim 3. Further features according to the invention may be gathered from the dependent claims, and their advantages are explained in the following description.

### IN THE DRAWING

FIG. 1 shows a side view of a milling machine

FIG. 2 shows the section A-A in a view from above

FIG. 3 shows a lateral section of the milling machine in use

FIG. 4 shows a lateral section of the milling machine with the shaft raised

FIG. 5 shows a sectional diagram of a treated surface

FIG. 6 shows the section B-B of the treated surface

FIG. 7 shows, in a detailed view, the section B-B of a treated surface.

The figures illustrate possible exemplary embodiments which are explained in the following description.

### REFERENCES IN THE DRAWING

1 Basic frame
2 Drawbar
3 Hand-operated hydraulic pump (for rapid lifting)
3.1 Handwheel (for fine setting)
3.2 Operating lever (travel drive forward/back)
4 Stroke guides
5 Housing
6 Shaft
7 Wheels
8 Drive
9 Hydraulic pump
10 Disk-shaped tool
11 Hydraulic cylinder (rapid lifting)
20 Floor covering
21 Groove
22 Ribs
a Spacing of the grooves 21
b Width of the grooves 21
t Depth of the grooves

Known methods, by means of individual cutters mostly fastened on drums, knock away parts of floor coverings to be processed. Since a multiplicity of such cutters are fastened over the circumference and width of such drums, a continuous removal of the surface is achieved over the entire width of the drum. As explained initially, such methods are employed successfully for road coverings and hard surfaces in the open.

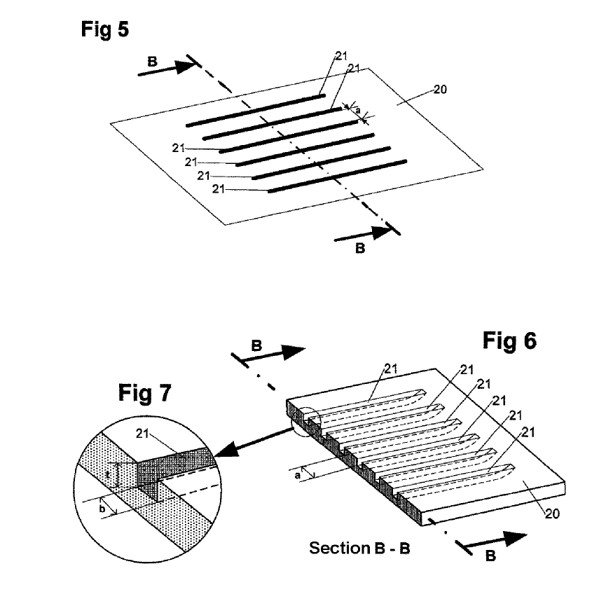

The proposed method is based on the idea of previously weakening a surface by means of a multiplicity of milled-in grooves 21 (FIG. 5), so that the residue still present can be knocked away by simple means in a second operation. Tests have shown that relatively gentle work, even within closed spaces, is possible in this way.

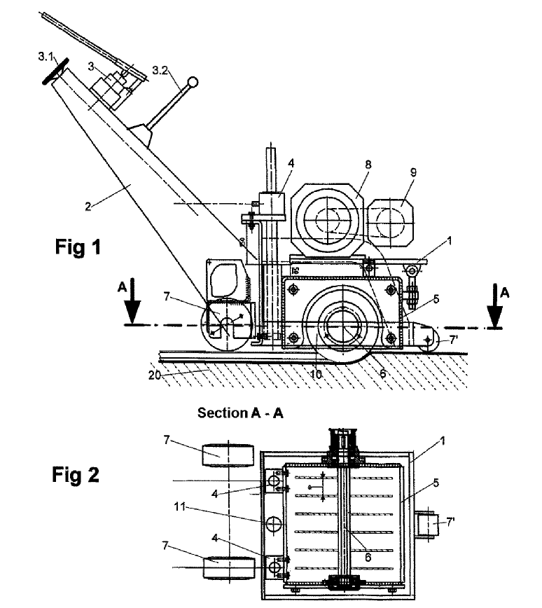

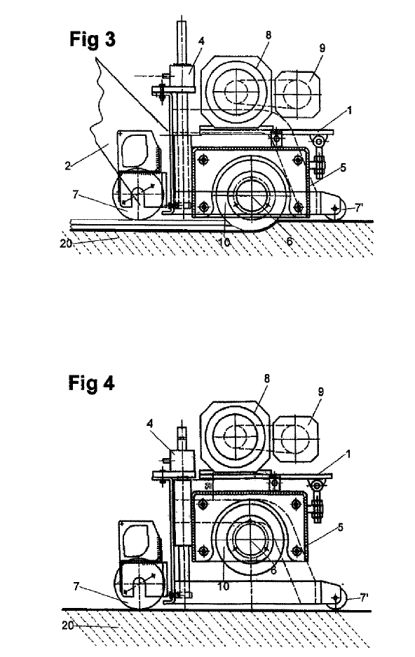

By means of the apparatus present in FIG. 1 to FIG. 4, up to 24 grooves 21 are simultaneously milled into the floor covering 20 at spacings a of 5 mm to 30 mm. These grooves 21 may have a depth of up to 40 mm. Depending on the type of material of the floor covering 20, the spacings a of the grooves are milled in order to obtain a pattern according to FIG. 5. The ribs 22 (FIG. 6) still present after processing can then easily be removed by means of bricklayer's hammers or picks. This method is suitable for all types of floor coverings. In particular, even glued laminates or carpets can thereby be removed more easily.

In the case of especially compact surfaces with high strength, the covering is provided with grooves 21 in one direction in a first operation (FIG. 5). In a second operation, the remaining ribs 22 are again provided with grooves 21 transversely thereto, so that ribs 22 do not remain, but, instead, rectangular elevations which can be knocked off with ease. The covering is normally glued to a layer of mortar or cement. During processing, fine and extremely disagreeable dust arises as a result of the removal of this mortar and spreads out everywhere. To avoid this, it is recommended that the disk-shaped tools 10 of the apparatus described below be cooled with water. This water at the same time binds the dust which can then be sucked up together with the contaminated water.

In order to carry out this method, an apparatus according to FIG. 1 to FIG. 4 is used. This consists of a basic frame 1 which stands on wheels 7, 7′ and which is guided by means of a drawbar 2. The operating elements 3, 3.1 and 3.2 are mounted on this drawbar 2. By means of the operating lever 3.2, the apparatus is moved forward and backward and the advance of the driven wheels 7 is controlled. The handwheel 3.1 serves for the fine setting of the working height of the housing 5 in which the disk-shaped tool 10 rotates on a shaft 6. The depth t of the grooves is set by means of this handwheel 3.1, while the hand-operated hydraulic pump 3 can quickly execute the rapid raising and lowering of the housing 5 into and out of the processing region. As described above, a shaft 6 is installed, mounted on both sides, in the housing 5. Disk-shaped tools 10 equipped with cutting edges are fastened on this shaft 6 at freely selectable spacings a.

The shaft 6 is driven by the drive 8 via a belt. The hydraulic pump 9 is likewise driven by the drive 8 via a second belt. The hydraulic pump 9 serves for moving the driven wheels 7 forward and backward by means of a hydraulic motor. This advancing movement is initiated by means of the operating lever 3.2. The hydraulic pump 9 delivers the necessary pressure so that the driven wheels 7 can be moved by means of the hydraulic motor.

The housing 5 is held in the basic frame 1 so as to be vertically moveable along the stroke guides 4 via a hydraulic cylinder 11 (FIG. 1). A shaft 6, mounted on both sides, is accommodated in the housing 5. Disk-shaped tools 10 equipped with cutting edges are fastened on the shaft 6 at uniform spacings a. The housing 5 can be moved with respect to the basic frame 1 vertically along the stroke guides 4 with high advance, for rapid raising and lowering, as a result of the movement of the hydraulic cylinder 11 which is itself operated by the hand-operated hydraulic pump 3.

The disk-shaped tools 10 fastened on the shaft 6 are equipped with cutting edges of various materials. There is provision for small diamond or hard metal tools attached to the circumference of the disk-shaped tools 10 to mill the grooves 21 into the floor covering 20. The disk-shaped tools 10 may be mounted on the shaft 6 at any desired spacings a. These spacings a are adapted, as a rule, to the floor covering to be processed and range between 5 mm and 30 mm. Depending on the type of floor covering to be processed, different disk-shaped tools 10 are employed. Their width varies between 1 mm and 10 mm so that grooves with a width b of 3 mm to 10 mm can be cut in by milling.

1. A method for the removal of floor coverings, wherein up to 24 grooves (21) with a width (b) of 3 mm to 10 mm and with a depth (t) of up to 40 mm are simultaneously milled into the floor covering (20) at spacings (a) of 5 mm to 30 mm.

2. The method as claimed in claim 1, wherein the spacings (a) of the grooves (21) are adapted to the type of floor covering (20), so that the ribs (22) remaining have a thickness (s) of 5 mm to 30 mm.

3. An apparatus for the removal of floor coverings, consisting of a basic frame (1) which stands on wheels (7, 7′) and which is guided by means of a drawbar (2), operating elements (3, 3.1, 3.2), by means of which the forward, backward and stroke movements are controlled, being mounted on this drawbar (2), there being fastened on a housing (5) a drive (8), by means of which a shaft (6) mounted on both sides of the housing (5) and a hydraulic pump (9) are driven via belt drives, this hydraulic pump (9) delivering the pressure for the drive to the wheels (7), with the aid of which the forward and backward movement takes place, wherein, in a basic frame (1), there is a housing (5) which is held vertically displaceably and in which the shaft (6) is mounted on both sides, disk-shaped tools equipped with cutting edges being fastened on the shaft (6) at adjustable spacings (a), and the housing (5) being moveable linearly/vertically with respect to the basic frame (1) as a result of the movement of the stroke elements (4).

4. The apparatus as claimed in claim 3, wherein the disk-shaped tools on the shaft (6) are provided with diamond cutting edges.

5. The apparatus as claimed in claim 3, wherein the disk-shaped tools (10) are arranged at spacings (a) of 5 mm to 30 mm.

6. The apparatus as claimed in claim 3, wherein the disk-shaped tools are designed in such a way that the milled grooves (21) have a processing width (b) of 3 mm to 10 mm.
